(19) United States
(12) Patent Application Publication
(10) Pub. No.: US 2005/0110810 A1
(43) Pub. Date: May 26, 2005

(54) Brightness adjusting circuit

(75) Inventors: Chian-Yie Lee, Taipei City (TW); Wen-Chang Yang, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 10/950,458

(22) Filed: Sep. 28, 2004

(30) Foreign Application Priority Data
Nov. 26, 2003 (TW) 092133214

(51) Int. Cl. G09G 5/10

(52) U.S. Cl. 345/690

(57) ABSTRACT

A brightness adjusting circuit for a display device has a brightness adjusting button on the display. When the user presses the brightness adjusting button, the brightness adjusting circuit reads display parameters stored in the memory and adjusts the brightness of the display device according to the display parameters to satisfy different brightness requests from the user for different applications.

### BACKGROUND OF THE INVENTION

1. Field of the Invention

The present invention relates to a brightness adjusting circuit and, more particularly, to a brightness adjusting circuit for a display device.

2. Description of the Related Art

Display devices are the major output devices for computer systems, providing to the user visual output data, such as text and graphical images, obtained from the computer system. However, the typical computer system is used not only as a document processing device, but also serves as a platform for surfing the Internet, playing computer games and viewing multimedia documents. When the user performs document processing on the computer device, he or she typically will not require a richly colored display; on the other hand, the viewing of multimedia documents generally requires rich colors and dynamic displaying; therefore, the user will generally want levels of color saturation and contrast. Display devices can typically increase color saturation and contrast by increasing the brightness of display device. However, higher color saturation and contrast tend to reduce the lifetime of the display device, so display device manufacturers must sacrifice one of these characteristics for the other.

Therefore, it is desirable to provide a brightness adjusting circuit to mitigate and/or obviate the aforementioned problems.

### SUMMARY OF THE INVENTION

A main objective of the present invention is to provide a brightness adjusting circuit which adjusts output of a driving circuit of a display device to adjust the brightness of the display.

Another objective of the present invention is to provide a brightness adjusting circuit which informs the user of the displaying mode of the display device.

In order to achieve the above-mentioned objectives, there is provided a brightness adjusting circuit for outputting an amplification signal to a display driving circuit to adjust the brightness of a display. The brightness adjusting circuit comprises a brightness adjusting button for outputting a switch signal; a memory for storing a plurality of corresponding brightness parameters; a microprocessor for reading the plurality of corresponding brightness parameters according to the switch signal and outputting a brightness limitation signal and a display parameter according to the corresponding brightness parameters; a brightness limiter for outputting a working voltage according to the brightness limitation signal; and a video amplifier for outputting the amplification signal according to the working voltage.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a display device; and

FIG. 2 is a functional block drawing of a brightness adjusting circuit according to the present invention.

### DETAILED DESCRIPTION OF THE PREFERRED EMBODIMENT

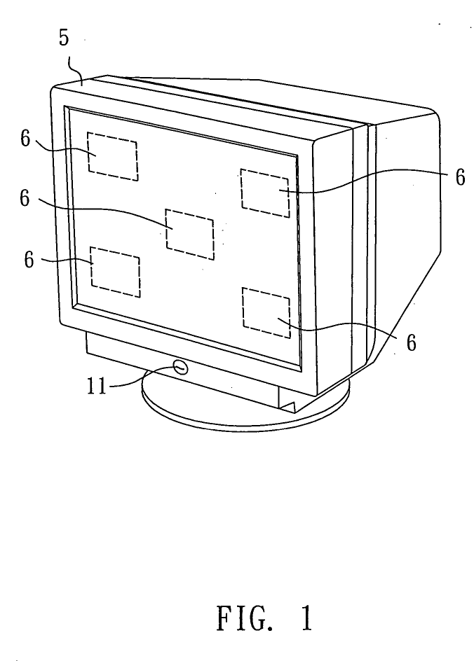

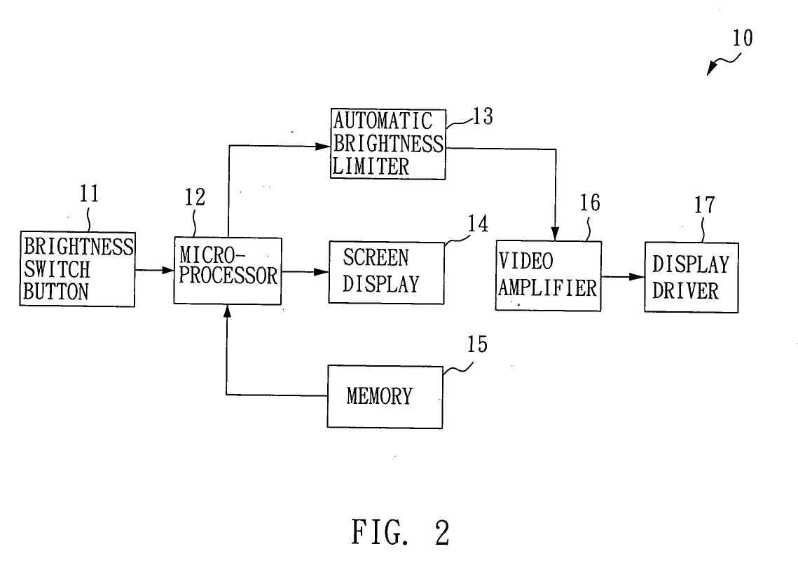

Please refer to both FIG. 1 and FIG. 2. FIG. 1 is a schematic drawing of a display device. FIG. 2 is a functional block drawing of a brightness adjusting circuit according to the present invention. A brightness adjusting circuit 10 can output limitation voltages with different voltage levels, or limitation signals with different characteristics, to change a driving voltage output by a display driver 17. Since the driving voltage has a positive relationship with the brightness of a display device 5, the brightness of a display device 5 can be adjusted to satisfy the user's different brightness requests. The display device 5 is preferably a CRT.

The brightness adjusting circuit 10 comprises a brightness switch button 11, which is placed on a surface of the display 15. When a user wants to adjust the brightness of the display device 5, he or she needs only press the brightness switch button 11, and the brightness switch button 11 outputs a switching signal to a microprocessor 12 for further processing, enabling the display device 5 to be switched among three display modes: a text mode, a game mode, and a multimedia mode. Different display modes correspond to different display brightness to satisfy different brightness requests from the user as desired for different applications.

The microprocessor 12 is used to store a current display mode of the display 5. When the switching signal is input, the microprocessor 12 reads a brightness parameters corresponding to the next display mode from a memory 15 according to the switching signal. The microprocessor 12 then outputs a brightness limitation signal and a display parameter, according to the corresponding brightness parameters, to a brightness limiter 13 and an on screen display (OSD) 14. For example, if the display 5 is in text mode, when the user presses the brightness switch button 11, the microprocessor 12 reads a display parameter corresponding to the game mode (which is the next display mode) from the memory 15 and performs a process according to the display parameter to output the corresponding brightness limitation signal to the brightness limiter 13 to adjust the brightness of the display 15. Then the microprocessor 12 outputs the corresponding display parameter to the OSD 14 to inform the user of the current display mode. A preferred mode switch sequence is text mode, game mode and multimedia mode.

The automatic brightness limiter (ABL) 13 is used for adjusting a brightness according to the brightness limitation signal. A maximum brightness measurement of the display device 5 is based on an average brightness (because the display device 5 is rarely shown in pure white) displayed by a plurality of small white blocks 6 (such as five small white blocks that are 6 cm²). The brightness of a pure white displayed image is 70˜80% of the brightness of the small white block 6. Although the brightness of display 5 can be increased for viewing multimedia or playing a game, the power consumption of the display 5 is increased, which can cause the display device 5 to lose focus, the brightness of the pure white color be too bright, and diminish the lifetime of phosphor. In order to reduce damage to the internal circuitry of the display device 5, and to increase the lifetime of phosphor, the automatic brightness limiter 13 controls a working voltage of a video amplifier 16 to limit a maximum brightness of the display device 5 for each display mode. For example, in the text mode, the automatic brightness limiter 13 provides 1.5 volts as the working voltage for the video amplifier 16, so that the brightness of the small white block is 40 FL (in units of candella/m²); in the game mode, the automatic brightness limiter 13 provides 2.0 volts as the working voltage for the video amplifier 16, so that the brightness of the small white block is 90 FL; in the multimedia mode, the automatic brightness limiter 13 provides 2.5 volts as the working voltage for the video amplifier 16, so that the brightness of the small white block is 150 FL. Therefore, the user can request different brightness according to the different application modes. Certainly, the brightness limiter 13 can also output different limitation signals to the video amplifier 16, and the video amplifier 16 outputs different amplification signals according to the limitation signals, so as to adjust an output of the display driver 17.

The on screen display (OSD) 14 has a user interface to inform the user of the current display mode and its corresponding brightness. For example, in the text mode, when the user presses the on screen display 14, the on screen display 14 utilizes the user interface to indicate that the current display mode will be changed to the game mode, and that the brightness will be changed from 40 FL to 90 FL.

The memory 15 is used for storing the brightness parameters for the microprocessor 12 to read. One set of brightness parameters corresponds to one display mode; for example, in the text mode, the corresponding white brightness parameters provide a red element set at 70 (maximum to 225), a green element set at 65, a blue element set at 85, and a working voltage of 1.5 volts; in the game mode, brightness parameters have the red element set at 95, the green element set at 100, the blue element set at 110, and the working voltage set at 2 volts; in the multimedia mode, the brightness parameters have the red element at 150, the green element at 160, the blue element at 170, and the working voltage at 2.5 volts. The memory 15 is preferably an EEPROM.

The video amplifier 16 is used for driving the display driver 17. When the working voltage is changed, or different limitation signals are input, the amplification signal sent from the video amplifier 16 to the display driver 17 are also changed to change the output of the display driver 17. For example, in the text mode, the optimal gain is 100; in the game mode, the optimal gain is 200; in the multimedia mode, the optimal gain is 300. The working voltage or the limitation signals are controlled by the brightness limiter 13.

The display driver 17 is used for driving the display device 5 to adjust its brightness, color, synchronizing signals, phase signals, etc according to the amplification signal. Since this display driver 17 is a prior art element, a detailed description is deemed unnecessary.

Although the present invention has been explained in relation to its preferred embodiment, it is to be understood that many other possible modifications and variations can be made without departing from the spirit and scope of the invention as hereinafter claimed.

1. A brightness adjusting circuit for outputting an amplification signal to a display driver to adjust the brightness of a display device, the brightness adjusting circuit comprising:
a brightness adjusting button for outputting a switching signal;
a memory for storing a plurality of corresponding brightness parameters;
a microprocessor for reading the plurality of corresponding brightness parameters according to the switching signal and outputting a brightness limitation signal and a display parameter according to the corresponding brightness parameters;
a brightness limiter for outputting a working voltage according to the brightness limitation signal; and
a video amplifier for outputting the amplification signal according to the working voltage.

2. The brightness adjusting circuit as claimed in claim 1 further comprising an on screen display (OSD), the microprocessor further outputting a display parameter according to the corresponding brightness parameter, and the on screen display being used for input and for displaying the display parameter.

3. The brightness adjusting circuit as claimed in claim 1 wherein the brightness limiter also outputs a limitation signal according to the brightness limitation signal, and the video amplifier outputs the amplification signal according to the limitation signal.

4. The brightness adjusting circuit as claimed in claim 1 wherein the memory is an EEPROM.

5. The brightness adjusting circuit as claimed in claim 1 wherein the brightness adjusting button is located on the display.

6. The brightness adjusting circuit as claimed in claim 1 wherein the display is a CRT.
